(19) United States
(12) Patent Application Publication
(10) Pub. No.: US 2019/0243805 A1
(43) Pub. Date: Aug. 8, 2019

(54) SYSTEM AND METHOD FOR BUILDING AND SEAMLESS PLAYING OF CONTENT MODULES

(71) Applicant: SORTING HAT TECHNOLOGIES PVT. LTD., Bangalore (IN)

(72) Inventors: Hemesh Singh, Bangalore (IN); Gaurav Munjal, Bangalore (IN); Alok Maurya, Bangalore (IN)

(73) Assignee: SORTING HAT TECHNOLOGIES PVT. LTD., Bangalore (IN)

(21) Appl. No.: 16/343,346

(22) PCT Filed: Dec. 22, 2017
(86) PCT No.: PCT/IN2017/050612

§ 371 Date: Apr. 18, 2019

(30) Foreign Application Priority Data
May 9, 2017 (IN) 201741016321

(51) Int. Cl. G06F 16/172; G06F 16/11; G06F 16/13

(52) U.S. Cl. CPC G06F 16/172; G06F 3/044; G06F 16/13; G06F 16/116

(57) ABSTRACT

The invention provides a system and method capable of building and seamlessly playing of content modules. In detail, the user application is configured to fetch content or data files in different formats from multiple sources and store it in separate memory locations. Further, the application allows the user to edit and enhance the content through adding annotations and voice recordings in sync with the collected data files in a pre-defined format and either upload it to the application platform or broadcast it directly to the viewers over application platform. The content modules may be viewed by the user or other person through the same application, which seamlessly play the content that makes it look like a video play.

### TECHNICAL FIELD

The field of the invention generally relates to a system and method of building and seamlessly playing of content modules, more specifically, the invention provides a system and method of building lessons/curriculum modules by fetching content from multiple sources and seamless playing of such built modules at different devices with multiple operating systems.

### BACKGROUND ART

With the advancement in the field of education, the education system is getting digitalized. Online learning systems have been evolving and growing over a period of time and gaining popularity. The online learning system aids to remove the financial barrier in the learning and self improvement process.

The e-learning and distance learning are the fastest growing areas in present day online learning system. E-Learning may either be an interactive session or a prerecorded session. Both modes help users in getting effective coaching. Also, coaching via internet even reaches people at remote locations and aids them in achieving excellence with ease.

Further, talking about advantages of e-learning, it mainly provides user with the flexibility of setting their own schedules and learn at their own pace. The e-learning experience can easily be enhanced with multimedia such as video, presentations, interactive websites and the like. The whole online learning system is often priced less than their physical counterparts.

There are multiple e-learning systems in existence, typically these learning systems provide online sessions which aid in distance learning at any instance of time and at any location. But the videos or any content available in the online learning environment are huge in size, hence require high speed internet connection, bigger memory space and consume higher bandwidth. It is desirable to have a system that is able to create a seamless online learning experience with reduced memory consumption and lower bandwidth consumption.

Hence, to overcome the above mentioned problem, there is need of a system and method which can easily build and play the lessons using less internet data and consume less bandwidth. It is also desirable that the system provides a real time interaction with the content to be delivered.

### OBJECT OF INVENTION

The principle object of the invention is to provide a system and method of building and seamless playing of content modules.

Another object of the invention is to provide a system and method of allocating separate memory locations for different data formats.

Yet another object of the invention is to provide a system and method of converting data from multiple formats other than image and video formats, to a standard format.

Yet another object of the invention is to provide a system and method of fetching content from multiple data sources.

Yet another object of the invention is to provide a system and method for uploading content of lesson in different templates.

### SUMMARY OF INVENTION

The invention provides a system and a method of building and seamless playing of content modules where the system comprises of a first user device in communication with a processor where the processor receives a data fetch instruction from the first user device and collects data from multiple sources in multiple formats.

The processor further converts the multiple data formats to a standard format using data conversion module and an editing module associated with the processor builds a data flow using the standard format data or data files.

Further, a second user device is configured with a viewing module to fetch the data files stored in a memory of the first user device and play the data files seamlessly in order of the data flow to obtain a content module.

### BRIEF DESCRIPTION OF DRAWINGS

This invention is illustrated in the accompanying drawings, throughout which, like reference letters indicate corresponding parts in the various figures.

The embodiments herein will be better understood from the following description with reference to the drawings, in which:

FIG. 1 depicts/illustrates a network system showing the interaction between a user device and a server, in accordance with an embodiment of the invention.

FIG. 2 depicts/illustrates a user device details with respect to the building of content modules, in accordance with an embodiment of the invention.

FIG. 3 depicts/illustrates a user device details with respect to seamless playing of content modules, in accordance with an embodiment of the invention.

FIG. 4 depicts/illustrates working details of a server, in accordance with an embodiment of the invention.

FIG. 5 depicts/illustrates in detail the types of templates used for uploading content modules, in accordance with an embodiment of the invention.

### DESCRIPTION OF EMBODIMENTS

The embodiments herein and the various features and advantageous details thereof are explained more fully with reference to the non-limiting embodiments that are illustrated in the accompanying drawings and/or detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The embodiments here in below provide the details of a system and method that is capable of building and seamlessly playing content modules in a single/multiple frames seamlessly, which makes it look like a video play. The user imports required data files for building content modules from various different sources such as device memory, camera, cloud, server and the like. Further, the data files may be in different formats such as images, documents, videos, etc.

The capacitive touch display configured in the user device aids to edit and enhance the content of the lessons by adding annotations and/or write/draw contents using touch, highlighter, stylus, etc over the content and the user can also record the audio while interacting with the content and then preview and publish the content modules to the platform. The published content modules can be seamlessly played using the video playing application.

In the present disclosure, the user device may be referred to any device which is capable of interacting with a server that can fetch content from multiple sources to build and seamlessly play content modules. The user device may be smart phone, tablet and computer and the like.

In the present disclosure, the application environment may be an interface for interaction between the user and the server or hardware to build the lessons.

Referring now to the drawings, where similar reference characters denote corresponding features consistently throughout the figures, there are shown preferred embodiments.

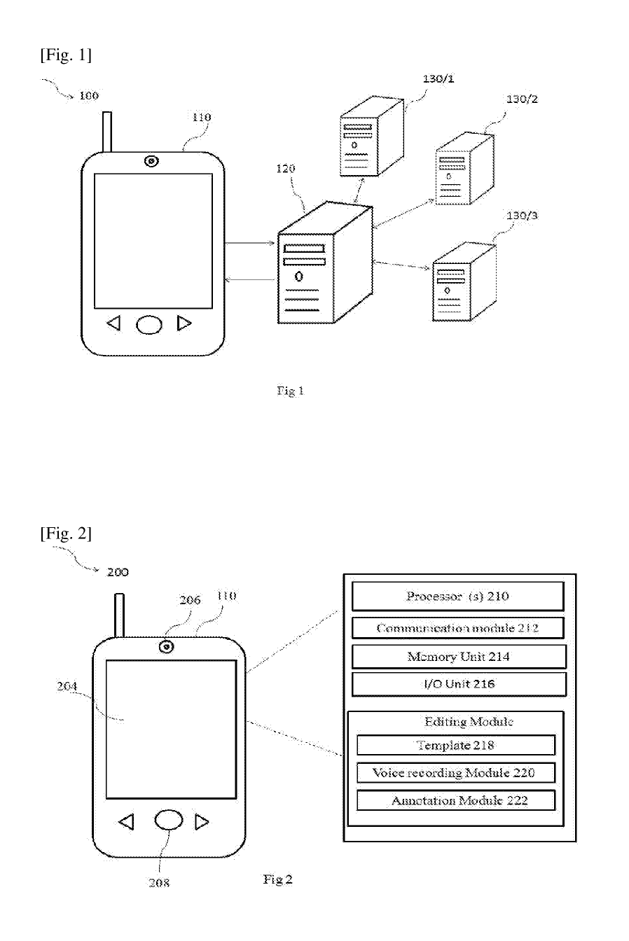

FIG. 1 depicts/illustrates a network system 100 showing the interaction between a user device 110 and a server 120, in accordance with an embodiment of the invention According to the system 100, the user device 110 is configured to build and seamlessly play the content of content module in a single frame. To build the content module, the user imports related content from multiple sources in various different formats.

In another embodiment, the different formats of data may be image, audio, video, document and presentation which are converted to a standard format.

Further according to FIG. 1 the user fetches content required for building content modules from user device memory, camera and gallery or from the server 120, which in turn interacts with the other third party servers 130 to fetch the content required by the user and transmit the content to the user device 110. The user device 110 builds, preview and publish the content modules to the platform which can be seamlessly played and viewed by other users.

In one embodiment, the content modules may be a curriculum module, lessons and the like.

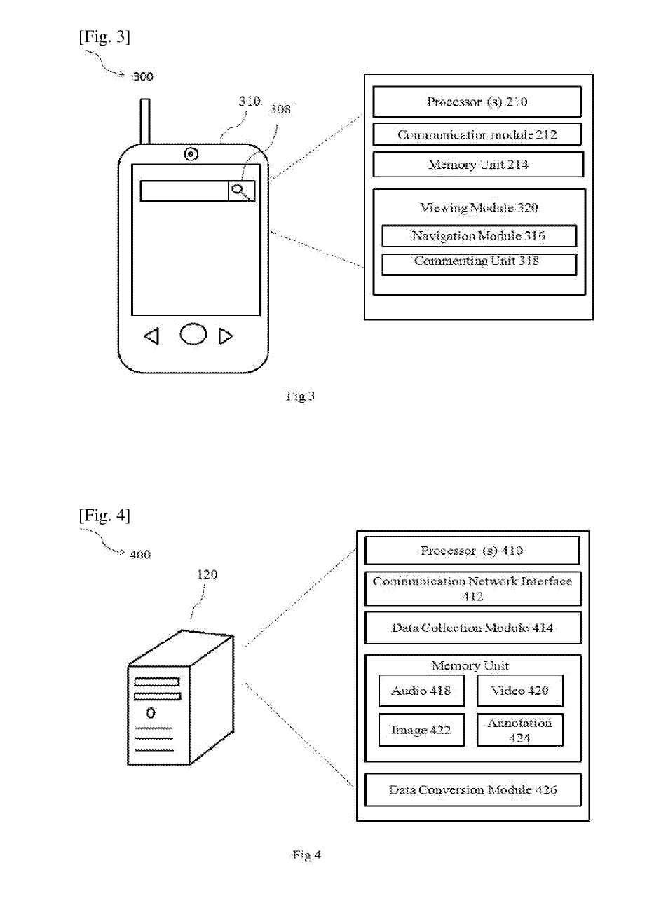

FIG. 2 depicts/illustrates details 200 of a first user device 110 with respect to the building of content modules, in accordance with an embodiment of the invention. The first user device 110 is capable of sending instruction in order to fetch content or files from multiple sources, camera 206 embedded in the user device may be one such source. The communication module 212 configured in the user device 110 aids to interact with the server to fetch the content or files. The content or files may be in multiple formats, they are allocated separate locations in the memory unit 214. The data in various formats are all converted to one standard format by data conversion module 224, for example, formats other than image and video formats are converted to a standard image format, which is further used by the first user device 110 for building of content modules.

Coming to the process of building content modules, the user device 110 collects multiple content associated with a particular subject matter, collected content is put in a specific template 218. The template 218 may further enable user to input voice by pressing a recording button 208 on the user device 110 which enables the voice recording module 220 to record the voice. Recorded voice is one of a data file that constitutes a data flow in the template 218 or template data flow. The user device 110 is configured with a capacitive touch display 204 which enables annotation module 222 to add annotations on fly over the content. Annotations may be highlighting, striking out, adding/writing over the content. These annotations may be considered as another set of data files and forms the part of the template data flow. The processing unit 210 incorporated in the first user device 110 is configured to store the said template data flow which includes data files such as voice recording, annotations and standard formatted data (images/videos) in said memory 214, where each data file is stored as an independent file.

Further, the application environment configured in the user device 110 enable the arrangement of data files in the template data flow. For example, the templates 218 helps voice recording files to be updated in synchronization with the image and video files and the annotations to the platform.

The created final template data flow, containing data files may be treated as a content module or a lesson.

In one embodiment the application may be a mobile application or the web application that allow the user to interact with the content in real time.

FIG. 3 depicts/illustrates details 300 a second user device 110 details with respect to seamless playing of content modules, in accordance with an embodiment of the invention. The user views the content modules through the video viewing module 320 configured in the second user device 110, which seamlessly displays template data flow having different data files such as the voice recording files and annotations in synchronization with the standard formatted data(image and/or video) fetched by the processor 210 from memory 214. The content module is played in a predefined order with a single/multiple frames. In one embodiment, the first and second user device may a single device.

To brief on the process further, when a user logs into the second user device 110 and open a specific content module or a lesson, the processor fetches the data files stored independently in different allocations of memory unit 214 and plays it seamlessly in a predetermined order or a template dataflow.

In one embodiment, the user logging in to the second user device 110 may view the content modules in real time through the viewing module 320. Also, the user may interact with content while viewing in real time through many ways such as, the user may talk to the person building the content module by leaving voice notes or by sending live video recordings. The user may further leave comment or write over the content module in real time using capacitive touch, stylus and the like. For example, if user 1 is building the content module in user device 1 then user 2 may view the building of the content modules and interact with the user 1 on the go rather than fetching the stored content modules later.

Further, the other users, who watch the content module, has options of leaving comments after viewing the lesson. Also, there is a search option 308 available in the user device for searching the content module the user desires to view. Once the required content is fetched by a user, the user can navigate between different content modules using navigation module 316. If a user wants to comment or discuss a particular content, then the system 300 allows him/her to interact with the content in real time using interaction unit 318.

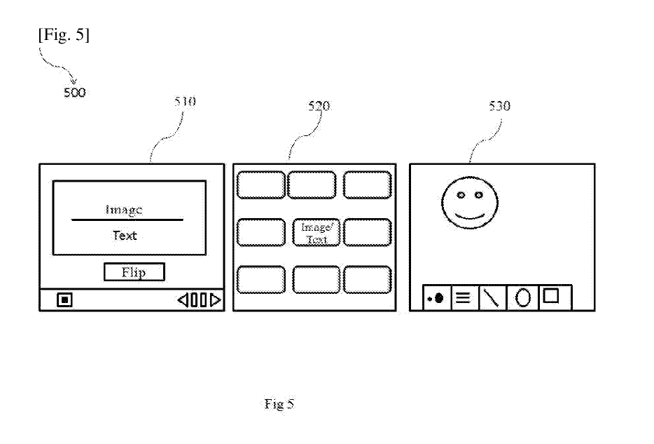

FIG. 4 depicts/illustrates details 400 of working of a server 120, in accordance with an embodiment of the invention The user fetches content related to a subject matter, from multiple sources in different formats and stores it in the memory unit, the server 120 is configured with the content request module 414 that requests the necessary content from other third party servers and stores the content in the memory unit, which has a separate allocation for different data formats such as audio 418 to store audio files and voice recording files, video 420 to store video files, image 422 to store image files and annotation 424 to store annotation files.

Further, a data conversion module 426 is configured in the said server 120, where all the data files of different formats are converted to a standard format of image or video. The processor 410 fetches the different files such as video files, image files, voice recording files and annotation files from the different memory locations in a predetermined order and the communication module 412 communicates the said files to the user device, which are played in predetermined order seamlessly in a single frame.

FIG. 5 depicts/illustrates in detail the types of templates 500 used for uploading content modules, in accordance with an embodiment of the invention. The application environment is configured to provide different templates 500 for uploading of content modules to the platform. For example, the templates may be in the form of flash card 510, matrix 520 or just drawing 530.

In one embodiment template may be any type of pre-defined content representation. Also, the templates allow the viewer (second user) to edit, modify, annotate, draw and the like over the content.

The above mentioned invention may used as a system and method which aids to reduce the utilization of bandwidth and allows the user building curriculum guides to interact with the content in real time. The described system also helps in creating high quality lessons accessible at any instant of time and requires less internet bandwidth that saves time and data costs.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

1. A system for building and seamless playing of content modules, said system comprising:
a first user device configured to send a data fetch instruction;
a processor in communication with said first user device, said processor configured to receive said data fetch instructions and collect data in one or more data formats from one or more sources;
a memory unit in communication with said processor configured to store said data in said data formats;
said processor comprising—
a data conversion module configure to convert said data formats into a standard format wherein said standard format data is a data file; and
an editing module disposed configured to build a data flow using at least two said data files stored separately in said memory unit; and
a second user device configured with a viewing module wherein said viewing module configured to fetch each said data files from said memory unit and play seamlessly in order of said data flow to obtain said content module.

2. The system of claim 1 wherein said first user device and said second said user device may be a single user device.

3. The system of claim 1 wherein said processor may be disposed on a server and/or said user device.

4. The system of claim 1 wherein said sources may be camera, photo gallery, server database, third party servers and the like.

5. The system claim 1 wherein said standard format may be an image and/or a video format.

6. The system of claim 1 wherein said data file may be a standard format data, annotation, voice recording, video recording and the like.

7. The system of claim 1 wherein said first user device further configured with conductive touch screen which enables a user to input said annotation, voice recording and video recording.

8. The system of claim 1 wherein said editing module further configured with one or more templates which enable said user to create said dataflow.

9. The system of claim 1 wherein said viewing module further comprising of a navigation module.

10. The system of claim 1 wherein said viewing module further comprising of a commenting unit.

11. The system of claim 1 wherein said content module is a lesson.

12. A method for building and seamless playing of content modules, said method comprising:
fetching data from one or more sources in one or more data format;
converting said one or more data format into at least one standard format wherein said standard format data is a data file;
building a data flow using at least two of said data files;
storing each said data file in an independent file of a memory unit;
fetching each said data files from said memory unit; and
seamlessly playing of said data files in order of said data flow to obtain a content module.

13. The method of claim 12 wherein said sources may be camera, photo gallery, server database, third party servers and the like.

14. The method of claim 12 wherein said standard format may be a image and/or a video format.

15. The method of claim 12 wherein said data file may be a standard format data, annotation, voice recording, video recording and the like.
